(19) United States
(12) Patent Application Publication
(10) Pub. No.: US 2007/0012151 A1
(43) Pub. Date: Jan. 18, 2007

(54) TOOL GUIDING APPARATUS

(75) Inventor: Robert E. Yost JR., Elyria, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: INTERACTIVE TOOL TECHNOLOGY LLC, Cleveland, OH (US)

(21) Appl. No.: 11/457,861

(22) Filed: Jul. 17, 2006

Related U.S. Application Data
(60) Provisional application No. 60/700,006, filed on Jul. 15, 2005.

(51) Int. Cl. B26D 5/08

(52) U.S. Cl. 83/523

(57) ABSTRACT

A tool guiding device includes a first member, a second member and a third member. The second member connects to the first member. The second member includes an opening through which a working member of an associated tool extends. The third member connects to the first member. The third member includes a surface configured to contact an edge of an associated sheet that is to be cut by the associated tool.

This application claims priority to application Ser. No. 60/700,006, filed Jul. 15, 2005, which is incorporated by reference in its entirety herein.

### BACKGROUND OF THE INVENTION

In the construction industry, four feet by eight feet (4′×8′) sheets, for example plywood sheets, drywall sheets, Styrofoam sheets, etc., often need to be cut. At times, many sheets need to be cut to have the same dimensions. For example, a four feet by eight feet sheet is to be cut into a three feet by eight feet sheet. Accordingly, a one foot strip is cut from the sheet.

A guide can be useful to make these cuts. One known guide includes a single graduated bar having stationary clamps and a moveable guide each attached to the graduated bar. The clamps attach to a circular saw. To use this device, the guide is moved in relation to the clamps to adjust the distance that the saw resides from the guide, which correlates to the amount of the sheet that is to be cut from the original sheet.

Such a device has certain drawbacks. The known device is not very stable. The known device is not able to be used to form angled or mitred cuts. This known device cannot be used to make very thin cuts.

### SUMMARY OF THE INVENTION

A tool guiding device includes first and second spaced side members, a table and a guide. The table connects to the first member and the second member. The table includes an opening through which a working member of an associated tool extends. The guide connects to the first and second members. The guide includes a guide surface configured to contact an edge of an associated sheet that is to be cut by the associated tool.

A device includes a first member, a second member and a third member. The second member connects to the first member. The second member includes an opening through which a working member of an associated tool extends. The third member connects to the first member. The third member includes a surface configured to contact an edge of an associated sheet that is to be cut by the associated tool.

### BRIEF DESCRIPTION OF THE FIGURES

FIG. 1 is a first perspective view of a tool guiding device.

FIG. 2 is a second perspective view, opposite the first perspective view of FIG. 1, of the tool guiding device of FIG. 1.

FIG. 3 is a top plan view of the tool guiding device of FIG. 1.

FIG. 4 a bottom plan view of the tool guiding device of FIG. 1.

FIG. 5 is a first end elevation view of the tool guiding device of FIG. 1.

FIG. 6 is a second end elevation view of the tool guiding device of FIG. 1.

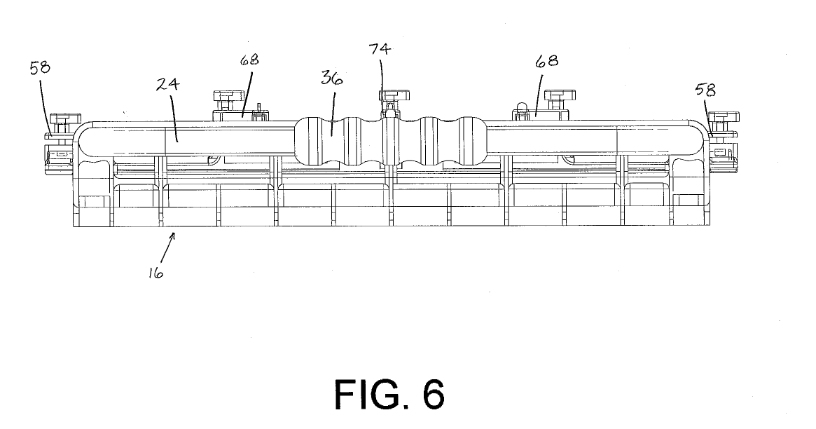

FIG. 7 is a side elevation view of the tool guiding device of FIG. 1.

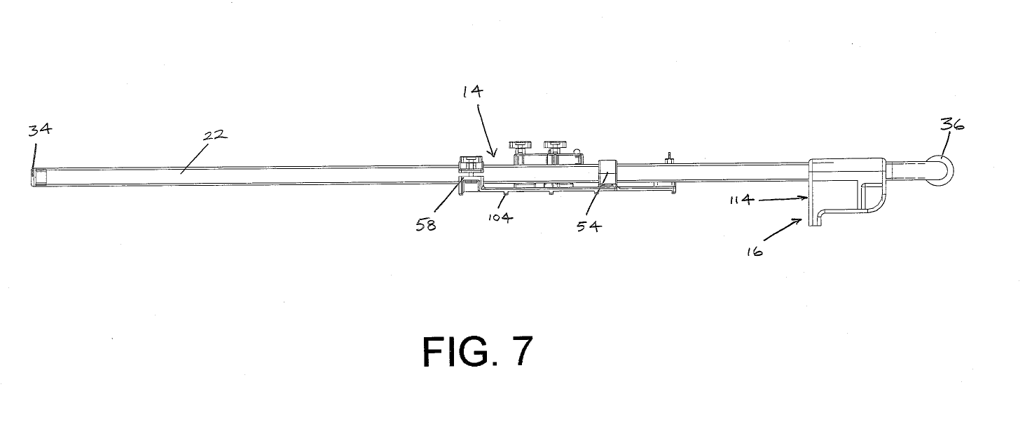

FIG. 8 is a perspective view of the tool guiding device including removable rail members and a storage location for the removable rail members.

### DETAILED DESCRIPTION OF THE INVENTION

The figures and written description presented below are provided to enable one skilled in the art to make and use a tool guiding device. The invention, which is defined by the appended claims, is not to be limited to only the embodiments disclosed in the figures and the written description.

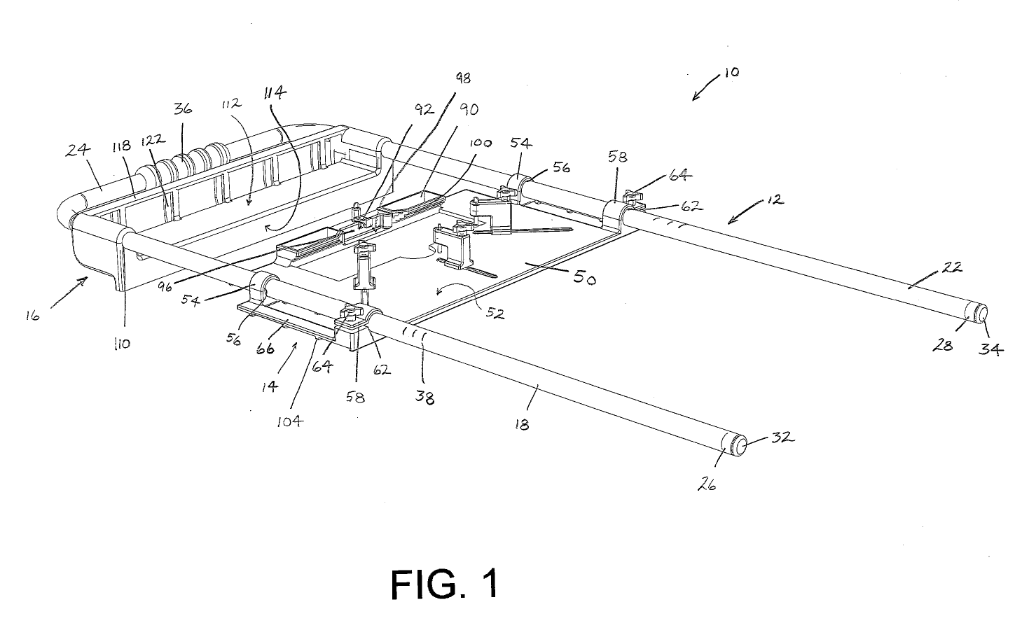

With reference to FIG. 1, a tool guiding device 10 includes a first member (rail) 12, a second member (table) 14 mounted to the rail, and a third member (guide) 16, which can also be referred to as a fence, mounted to the rail. The tool guiding device 10 is useful in guiding tools, such as a circular saw, a planer, a router, a jigsaw, a torch, a metal cutting device, etc. and accessories used with these tools, to make straight cuts in sheets such as plywood, drywall, styrofoam, composite boards, metal, etc. Nevertheless, the tool guiding device 10 can be useful in other manners as well.

In the depicted embodiment, the rail 12 is made from an extruded aluminum rod that is formed in a U-shaped configuration; however, the rail can be made from other durable materials or manufactured in other convenient ways. In the depicted embodiment, the rail 12 includes spaced parallel side members 18 and 22 that are connected by an interconnecting member 24. The spaced parallel side members 18 and 22 do not meet at their respective terminal ends 26 and 28. This configuration allows the table 14 and the guide 16 to be easily slid off of the rail 12, if desired, which also facilitates the manufacture of the tool guiding device 10. End caps 32 and 34 are preferably inserted into the hollow tubular ends 26 and 28 of the side members 18 and 22. The end caps 32 and 34 have a circular configuration and are made of plastic to soften any edges at the terminal ends of the spaced parallel support members, although it will be appreciated that other configurations and materials may be used without departing from the scope and intent of the present invention. The parallel support members 18 and 22 extend away from the interconnecting member 24 approximately two feet in the depicted embodiment. If desirable, however, the spaced members 18 and 22 can extend even further from the interconnecting member 36, for example, four to six feet. The side members 18 and 22 are spaced from one another a distance to accommodate the table 14 and the guide 16. A handle grip 36 is preferably provided on the interconnecting portion 24.

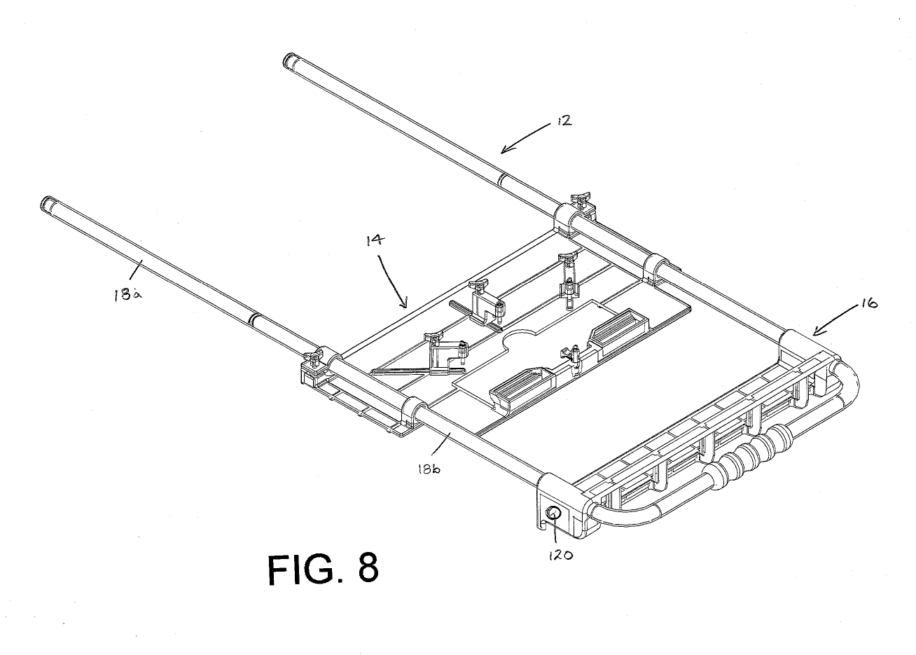

The device 10 can be manufactured so that the distance that the side members 18 and 22 extend from the interconnecting member 24 can be adjusted. For example, each side member can be made from a plurality of interconnected components. One component of the side member that is located adjacent the interconnecting member 24 (a proximal member 18a FIG. 8) can receive another component (a distal member 18b FIG. 8) of the same side member, or vise versa, such that a telescopic arrangement is provided. The proximal member can be rotated in relation to the distal member, or vice versa, to fix the portion of the distal member that extends from the proximal member. In another configuration, the distal member, i.e. the member furthest from the interconnecting member, can be removed from the proximal member. Such a configuration can provide a “knock down” feature for the device so that the device does not take up valuable space when not in use. Where a removable distal member is provided, the distal member can connect to the proximal member via a friction fit, a bayonet connection, or other similar conventional connection. It may be desirable to provide a quick disconnect between the proximal member and the distal member that does not require the use of hand tools to connect or disconnect the two from one another.

Graduation marks 38 (only a few are depicted in FIG. 1), for example inches marks and centimeters marks, are disposed on the side members 18 and 22. Furthermore, the rail 12 can take alternative configurations other than the U-shaped configuration that is shown. For example, the rail 12 can only include the side members 18 and 22 without the interconnecting member. In such a configuration, it may be desirable to provide stops at one end of side members 18 and 22 to stop the movement of the table 14 and guide 16 at this end of each side member.

In the embodiment depicted in the FIGURES, the table 14 slides along the rail 12. In the depicted embodiment, the table 14 is made of plastic; however, the table can be made of other durable, inexpensive, easy-to-manufacture materials. The table includes a platform 50 having an upper surface 52 upon which a tool, such as a router, a planer, a circular saw, a jigsaw, torch, etc., can rest. Forward extensions 54 connect to the platform 50 and include openings 56 that receive the parallel side members 18 and 22 of the rail 12. Rearward extensions 58 connect to the platform 50 and also include openings 62 to receive the rail 12. The rearward extensions are C-shaped such that a fastener 64 is used to clamp the rearward extension 58 against the rail 12. Accordingly, the location of the table 14 along the rail 12 is fixed. Braces 66 interconnect the forward extensions 56 and the rearward extensions 64 to provide more stability to the table 14.

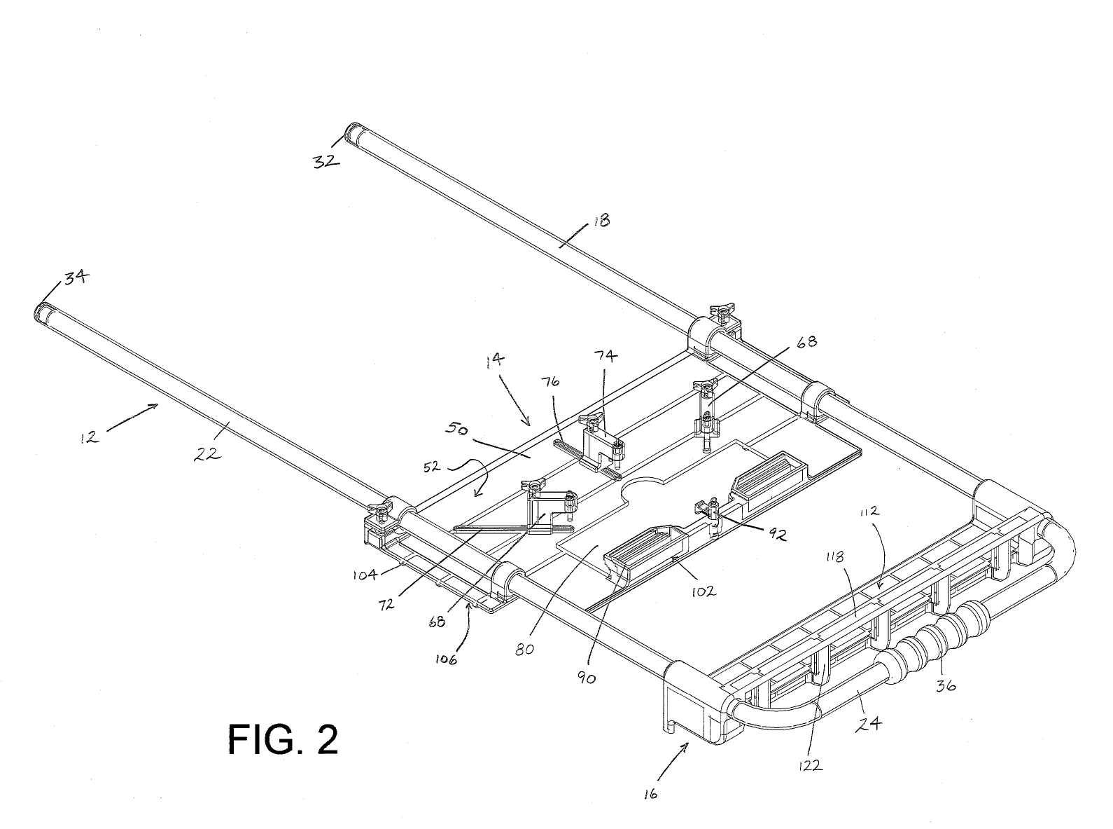

Clamps mount to the table to retain the tool thereon. Reference will now be made to FIG. 2 so that the FIGURES do not become cluttered. Outer clamps 68 are received in outer slots 72 formed in the platform 50 of the table 14. The outer slots 72 are preferably angled with respect to the parallel side members 18 and 22. Similarly, a central clamp 74 is received in a central slot 76 formed in the platform 50 of the table 14. The clamps 68 and 74 are mounted in the respective slots 72 and 76 so that they can be moved to accommodate different tools. The clamps contact an upper side of a base assembly of an associated tool (not shown), e.g. circular saw, pressing the base assembly against the upper surface 52 of the platform 50. In the depicted embodiment, the clamps include a fastener that is tightened to provide a downward force. Other conventional clamping devices can also be provided. The location of the clamps 68 and 74 on the platform 50 is adjustable so that the tool guiding device 10 can be used with a number of different tools from a number of different manufacturers. When located in the desired location(s), the clamp(s) are tightened and thereby securely mount the associated tool to the guiding device 10.

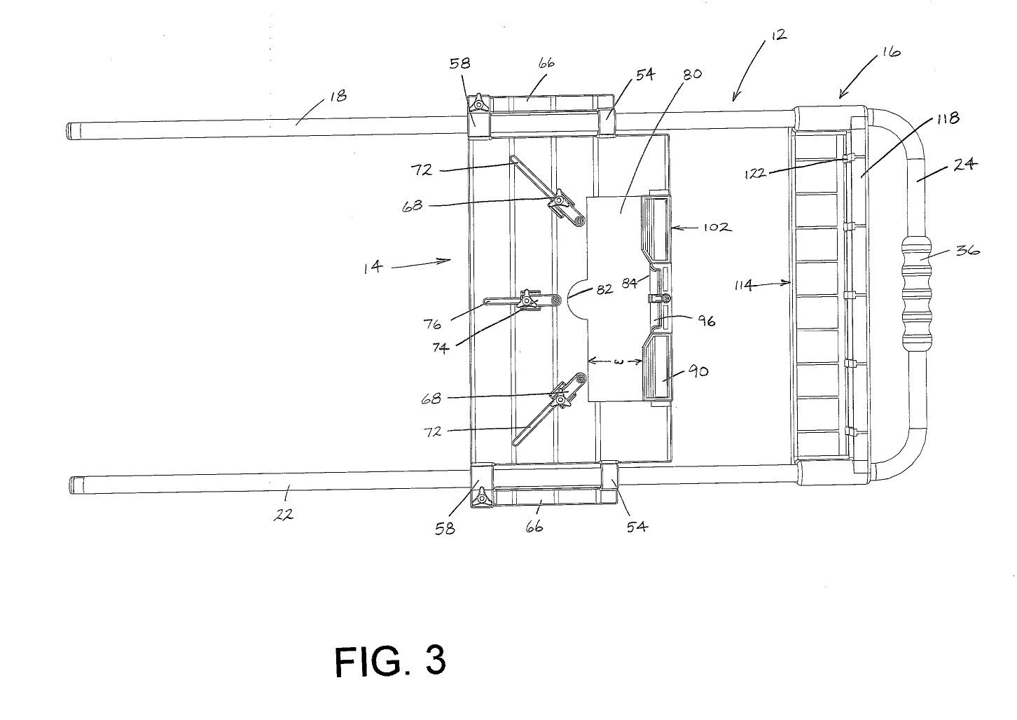

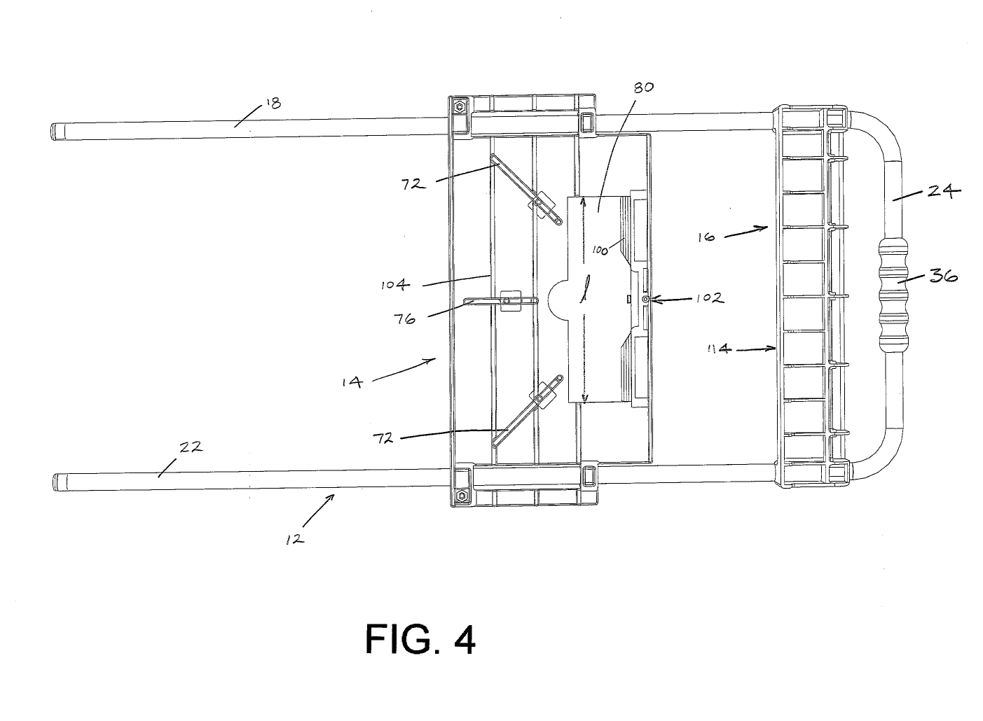

An opening 80 is provided in the platform 50 so that the associated working tool, for example the blade of a circular saw, the bit of a router, etc., extends through the opening to work on the sheet (not shown). As more clearly seen in FIG. 3, the opening 80 is generally rectangular in shape. The opening 80 includes a semi-circular edge 82 formed adjacent the central slot 76 in which the central clamp 74 resides. The semi-circular portion of the opening 80 allows the platform 50 to accommodate a router, for example, more easily. The opening 80 also includes a trapezoidal portion as defined by a trapezoidal edge 84 that is disposed across from the semi-circular edge 82. The trapezoidal edge 84 extends wider in a direction that is perpendicular to the side members 18 and 22 of the rail 12 than that of the semi-circular edge 82. The opening 80 has a dimension w (FIG. 3), i.e. a width, that is generally parallel to the spaced parallel side members 18 and 22 that is approximately 1½-6 inches. This width dimension of the opening 80 allows the opening to accommodate a circular saw disposed at an angle, for example where it is desirable to form an angled cut in the work sheet. The length/(FIG. 4) of the opening 80 is great enough so that a blade of a circular saw, for example a 7½″ blade or a 10″ blade, can extend through the opening without contacting the table 14.

With reference back to FIG. 1, a forward region 90 of the table 14 defines a leading edge of the opening 80 in the table. The forward region 90 extends upwardly from the upper surface 52 of the platform 50. A clamp 92 mounts to the forward region 90. The forward region 90 defines a recess 96 disposed underneath the clamp 92. The recess 96 includes a lower surface 98 that resides in the same plane as the upper surface 52 of the platform 50. The lower surface 98 can, if desired, extend along the length of the opening 80. Accordingly, the clamp 92 clamps the base assembly of an associated tool to the lower surface 98. The forward region 90 can also include a stepped surface 100 that generally faces toward the upper surface 52 of the platform. The stepped surface 100 is provided so that the base assembly of different tools can reside in one of the steps. One of the steps of the stepped surface 100 contacts an upper surface of the base assembly to limit upward movement of the base assembly near the forward region 90.

With reference back to FIG. 2, the forward region 90 of the table 14 defines a forward contact surface 102 that cooperates with the guide 16 in a manner that will be described in more detail below. The forward contact surface 102 resides in a plane that is perpendicular to the support surface 52 of the platform 50. Also, the plane of the forward surface 102 of the forward region 90 is the same plane of the direction of the cut that is to be made with the tool that is attached to the tool guiding device 10. The table 14 also includes small ridges 104 extending downwardly (toward the sheet to be cut) from a lower surface 106. The ridges 104 act as bond breakers to reduce friction as the table 14 moves over the sheet to be cut.

The guide 16 also attaches to the rail 12. In the depicted embodiment, the guide 16 is fixed on the rail 12 and is made of plastic; however, the guide can be made from other durable materials and can also be movable along the rail. In the depicted embodiment, the guide 16 is disposed such that it is interposed between the interconnecting member 24 of the rail 12 and the table 14 when the tool guiding device 10 is finally assembled. The guide 16 includes openings 110 that are formed and dimensioned to receive the spaced side members 18 and 22 of the rail 12. The guide includes a body having an upper surface 112 and a guiding surface 114.

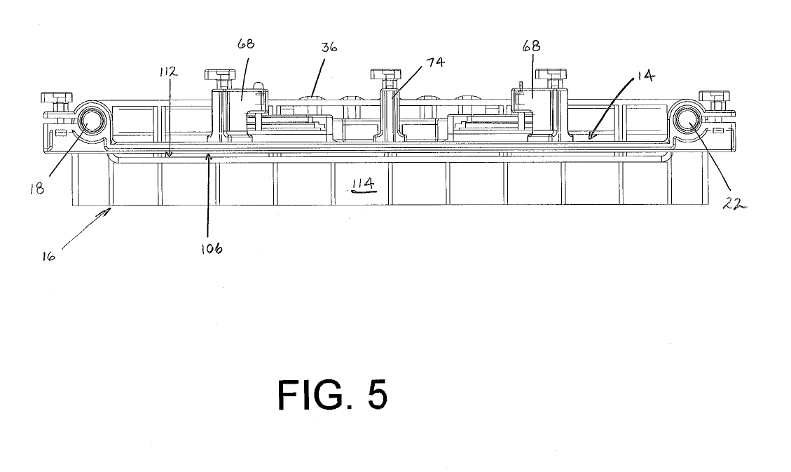

As more clearly seen in FIG. 5, the guide 16 is formed and dimensioned such that the upper surface 112 of the guide 16 fits underneath the lower surface 106 of the platform 50 of the table 14. Accordingly, the tool guiding device 10 can be used to cut very thin strips from a sheet.

With reference back to FIG. 2, the guide 16 also includes a forward brace 118 and a plurality of struts 122 that interconnect the forward brace to the body that includes the upper surface 112 and the guide surface 114. The upper surface 112 has a dimension extending from the struts 122 towards to guide surface 114 that is at least about equal to the width of the opening 80 in the table 14 so that a great portion of the upper surface 112 can fit underneath the platform 50 before the contact surface 102 of the table 14 contacts the struts 122 so that very thin cuts can be made in sheets.

In an embodiment that includes removable side members for the rail 12, the guide 16 can include openings 120 (FIG. 8) dimensioned to receive the removable side members, for example in a sidewall of the guide.

To use the tool guiding device 10; an associated tool (not shown) is mounted on the upper surface 52 of the platform and secured via the clamps 68, 74 and 92. Not all clamps need to be used. The location of the cut is determined by the distance between the guide surface 114 of the guide 16 and the working member, e.g. the blade and/or bit, of the tool mounted on the platform 50. The location of the table 14 and/or the guide 16 is adjusted to the desired location. The guiding surface 114 of the guide 16 extends along an outer straight edge of the sheet and the tool, which is attached to the platform 50, which is attached to the rail 12, moves along as a single unit to cut the sheet.

The tool guiding device has been described with reference to preferred embodiments. Modifications and alterations will occur to those upon reading and understanding the detailed description. It is to be understood that the description includes all such reasonable modifications and alterations that come within the scope of the appended claims.

What is claimed is:

1. A tool guiding device comprising:
first and second spaced side members;
a table connected to the first member and the second member, the table including a lower surface configured to rest on an associated sheet that is to be cut and an opening through which a working member of an associated tool extends; and
a guide connected to the first and second members, the guide including a guide surface configured to contact an edge of the associated sheet that is to be cut by the associated tool.

2. The device of claim 1, further comprising an interconnecting member connecting the first member to the second member.

3. The device of claim 1, wherein the table is connected to the first member and the second member such that the table can selectively move along the members.

4. The device of claim 1, further comprising a friction breaking member extending from the lower surface of the table.

5. The device of claim 1, further comprising a clamp mounted to the table, the clamp being configured to retain the associated tool with respect to the table.

6. The device of claim 5, further comprising an additional member disposed on an opposite side of the opening as the clamp, the additional member being configured to retain the associated tool with respect to the table.

7. The device of claim 6, wherein the additional member comprises at least one of a clamp and a stepped surface.

8. The device of claim 5, wherein the clamp is movably mounted to the table.

9. The device of claim 8, wherein the clamp includes a first clamp and a second clamp, the first clamp moves in a first axis and the second clamp moves in a second axis that is not parallel to the first axis.

10. The device of claim 1, wherein the opening has a dimension measured generally perpendicular to the first side member that measures at least about 10 inches.

11. The device of claim 1, wherein the opening is defined at least in part by a semi-circular edge.

12. The device of claim 1, wherein at least a portion of the guide is configured to reside underneath the table when at least one of the table and the guide is moved toward the other of the table and the guide.

13. The device of claim 1, wherein the first member and the second member each include a distal member and a proximal member, the distal member being moveable in relation to the proximal member.

14. The device of claim 1, wherein the opening is configured to accommodate an associated circular saw disposed at an angle to form an angled cut.

15. A device comprising:
a first member;
a second member connected to the first member, the second member including an opening through which a working member of an associated tool extends; and
a third member connected to the first member, the third member including a surface configured to contact an edge of an associated sheet that is to be cut by the associated tool.

16. The device of claim 15, wherein at least one of the second member and the third member connects to the first member such at least one of the second member and third member is movable along the first member.

17. The device of claim 15, further comprising a handle attached to the first member.

18. The device of claim 15, wherein the first member includes a detachable portion and at least one of the second member and the third member includes an opening configured to receive the detachable member.

19. The device of claim 15, wherein at least a portion of the third member is configured to be received underneath at least a portion of the second member.

20. The device of claim 15, wherein the opening has a dimension that is at least about seven and one-half inches.
